(19) United States
(12) Patent Application Publication
(10) Pub. No.: US 2013/0281323 A1
(43) Pub. Date: Oct. 24, 2013

(54) DEVICE AND METHOD FOR CELL-EXCLUSION PATTERNING

(71) Applicant: Elizabeth Tran, Painted Post, NY (US)

(72) Inventor: Elizabeth Tran, Painted Post, NY (US)

(21) Appl. No.: 13/450,852

(22) Filed: Apr. 19, 2012

(51) Int. Cl. C40B 50/06; B01L 3/00

(52) U.S. Cl. 506/26; 422/552

(57) ABSTRACT

This disclosure relates to devices and methods for cell-exclusion patterning. Specifically, this disclosure provides a device and method to exclude cells in selected areas during cell seeding and create cell-free arrays that can be used for cell migration and related studies and assays.

### TECHNICAL FIELD

The present disclosure relates in general to a cell culture device which provides an area which contains cells and an area which is free of cells. In one application, the cell culture device can be used perform assays to determine activity of a chemical entity, or cell motility assays.

### BACKGROUND

The following references are cited below in the description of the state of-the-art, where their contents are hereby incorporated by reference herein.
1. A high-throughput cell migration assay using scratch wound healing, a comparison of image-based readout methods. Justin C Yarrow, Zachary E Perlman, Nicholas J Westwood, and Timothy J. Mitchison. BMC Biotechnology 2004, 4:21.
2. Cell-Exclusion Patterning: Rehydration of Polymeric, Aqueous, Biphasic System Facilitates High Throughout Cell Exclusion Patternin for Cell Migration Studies Hossein Tavana, Kerim Kaylan, Tommaso Bersano-Begey, Kathryn E. Luker, Gary D. Luker, Shuichi Takayama, Cell-Exclusion Patterning: Rehydration of Polymeric, Aqueous, Biphasic System Facilitates High Throughput Cell Exclusion Patterning for Cell Migration Studies.
3. WO2009026359. Improved devices for Cell Assays.
4. US20090054162 Devices for Cell Assays.

This disclosure relates to devices and methods for cell-exclusion patterning. Specifically, this invention provides a device and method to exclude cells in selected areas during cell seeding and create cell-free arrays that can be used for cell migration and related studies and assays.

Cell migration and related processes are critical components of many physiologically important processes such as wound healing, angiogenesis, embryogenesis, cancer metastasis, and immune response. To date, a variety of methods have been developed for studying the migratory behavior of cells. These methods fall into two categories: those involving devices that can generate chemical gradients, such as TRANSWELLS® (Corning, Incorporated, Corning, N.Y.) and Boyden chambers, and those involving devices that can create cell-free areas in cell monolayers.

The creation of cell-free areas in cell monolayers is an important component of scratch/wound migration assays. The scratch/wound assays enable measurements of cell migration in the absence of a chemo-attractant. They often involve creating cell-free areas using tools such as a pipette tip, a syringe needle, a razor blade, a pin array, electric current, and laser light. While this approach enables monitoring of cellular responses in real-time, creating the cell-free area using these devices often results in damage to the cells at the edge of the wound and to the cell culture surface. In addition, the resulting cell-free areas are often inconsistent in size, shape, and location.

More recently, several cell-exclusion patterning methods have been developed as improved alternatives to the scratch/wound methods. Like the scratch/wound methods, the cell-exclusion patterning methods also involve the creation of cell-free areas in confluent cell monolayers. However, they do so using tools that not only do not damage the cells, but also can create cell-free areas of uniform size and shape. These tools include the use of silicone stoppers, and self-dissolving, biocompatible gel (BCG) to block the attachment of cells in predetermined areas during cell seeding. Both the silicone stoppers and BCG have been developed to provide a more reproducible alternative to the scratch/wound closure assay, and a less cumbersome method than TRANSWELL®/Boyden chamber devices for cell migration studies. However, for assays where the cell culture surface is coated with an extracellular matrix (ECM), the direct contact of the silicone stoppers and BCG with the ECM, as required by these approaches, may result in alteration of the ECM structure. In addition, it may leave behind residues that are undesirable.

### SUMMARY

The disclosure provides, in an aspect (1) a kit for cell-exclusion patterning comprising; a multi-well plate comprising a plurality of wells; a frame comprising at least a first side panel and a second side panel wherein the first side panel comprises a plurality of guide holes. In an aspect (2) the disclosure provides the kit of aspect 1 wherein the second side panel of the multi-well plate comprises a plurality of guide holes. In an aspect (3), the disclosure provides the kit of aspect 1 wherein the multi-well plate comprises a 96 well plate or a 384 well plate. In an aspect (4), the disclosure provides the kit of aspect 1 wherein the multi-well plate comprises a 96 well plate or a 384 well plate. In an aspect (5), the disclosure provides the kit of aspect 1, further comprising a comb, wherein the comb comprises: a comb having a bar; at least one guide pin extending from the comb bar; a plurality of blocking pins extending from the comb bar, each having a bottom surface; wherein the at least one guide pin is structured and arranged to engage with a first side panel of a multi-well plate and wherein the plurality of blocking pins are structured and arranged to extend into a plurality of wells of the multi-well plate. In an aspect (6), the disclosure provides the kit of aspect 5, wherein the comb comprises two guide pins, a first guide pin structured and arranged to engage with a first side panel of a multi-well plate, and a second guide pin structured and arranged to engage with a second side panel of a multi-well plate. In an aspect (7), the disclosure provides the kit of aspect 5 wherein the blocking pins are cylindrical. In an aspect (8), the disclosure provides the kit of aspect 5 wherein the bottom surface of the blocking pins is flat. In an aspect (9), the disclosure provides a kit for making a multi-well cell culture plate for cell-exclusion patterning comprising: (1) a comb, wherein the comb comprises: a comb bar; at least one guide pin extending from the comb bar; a plurality of blocking pins extending from the comb bar, each having a bottom surface; and, (2) A multi-well plate, wherein the multi-well plate comprises: a plurality of wells, each well having side walls and a well bottom; a first side panel and a second side panel; wherein the first side panel comprises a plurality of guide holes; wherein the at least one guide pin is structured and arranged to engage with one of the plurality of guide holes of the first side panel of the multi-well plate and wherein when the at least one guide pin is engaged with one of the plurality of guide holes of the first side panel of the multi-well plate, the plurality of blocking pins are inserted into the plurality of wells. In an aspect (10), the disclosure provides the kit of aspect 9 wherein the second side panel comprises a plurality of guide holes. In an aspect (11), the disclosure provides the kit of aspect 10 wherein the comb comprises two guide pins, structured and arranged to engage with a guide hole of the first side panel of the multi-well plate and a guide hole of the second side panel of the multi-well plate. In an aspect (12), the disclosure provides the kit of aspect 9 wherein the blocking pins are cylindrical. In an aspect (13), the disclosure provides the kit of aspect 9 wherein the bottom surface of the blocking pins is flat. In an aspect (14), the disclosure provides a method of using the kit of aspect 9 for making a multi-well cell culture plate for cell-exclusion patterning comprising; (a) engaging the comb with the multi-well plate so that the at least one guide pin is engaged with one of the plurality of guide holes of the first side panel of the multi-well plate and the plurality of blocking pins are inserted into the plurality of wells; (b) adding cell culture media to the wells of the multi-well plate; (c) adding cells to the wells of the multi-well plate; (d) allowing cells to settle to the bottom of the wells of the multi-well plate; (e) removing the comb from the multi-well plate.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be had by reference to the following detailed description when taken in conjunction with the accompanying drawings wherein:

FIG. 1 is a perspective drawing illustrating a multi-well cell culture plate and a comb, which form an embodiment of the kit disclosed herein.

FIGS. 2a and 2b are illustrations of the comb engaged with the multi-well plate.

FIG. 2a is a cross-sectional view of a comb 200 engaged with the multi-well plate 100.

FIG. 2b is a blown-up illustration of the area 20 shown in FIG. 2a.

FIG. 3A-E is an illustration of a method of using the multi-well plate and comb to create a cell-exclusion cell culture.

FIG. 4 is an illustration of the bottom of a cell culture well, having cells in a cell-exclusion ring.

FIG. 5 A-F is a series of micrographs showing cells growing in a cell-exclusion patterned cell culture in non-treated (NT) (A-C) and coated with Fibronectin (FN) wells (D-F).

FIG. 6 A-F are micrographs showing cells growing in a cell-exclusion patterned cell culture in uncoated the absence (A, C, and E) and presence (B, D and F) of a pharmaceutical agent (in this case, CytoD) in an assay.

FIGS. 7 A and B are micrographs showing cells growing in a cell-exclusion patterned cell culture in the presence (A) and absence (B) of a pin in the well.

FIG. 8 (A-F) are Heat map representations of A549 cells cultured atop a Corning Epic® biosensor, illustrating that cells grow into the cell exclusion zone when cultured over time.

### DETAILED DESCRIPTION

This disclosure provides a cell-exclusion patterning method to partition cells into cell-containing and cell-free areas during cell seeding so that subsequent migration and growth of cells from cell areas to cell-free areas can be observed, recorded and analyzed. In particular, this disclosure provides a device and method for patterning and depositing living cells in predetermined areas by a mechanism that does not involve direct contact of the device with the cell culture surface. The device and method therefore enable cell patterning without damage or change to either the cells or the cell culture surface. The device is simple and easy to use and comprises a set of equally spaced pins that 1) can be lowered into wells of microtiter plates so that the tip of each pin is near but not touching the bottom of the wells and 2) can function as a non-contact mask for blocking the deposition of cells in selected areas during cell seeding.

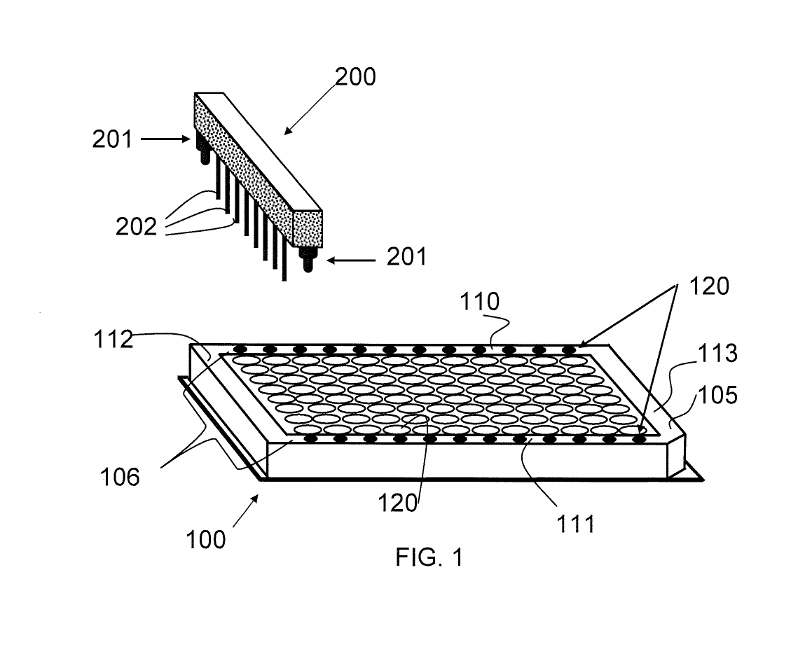

FIG. 1 is a perspective drawing illustrating a multi-well cell culture plate 100 and a comb 200, which form an embodiment of the cell-exclusion patterning kit disclosed herein. In embodiments, the multi-well plate 100 has a top surface. The top surface has at least a first panel 110, outside a plurality or an array of wells 106. In the embodiment shown in FIG. 1, four panels 110, 111, 112, 113 are shown, forming a frame 105 surrounding the plurality or array of wells 106. In embodiments, at least one panel 110 is adjacent to a plurality of guide holes 120. In embodiments, the multi-well plate comprises a plurality of wells 106, a frame 105 comprising at least a first side panel 110, wherein the first side panel 110 comprises a plurality of guide holes 120. In embodiments, the frame comprises a second side panel 111 wherein the second side panel comprises guide holes 120.

FIG. 1 also illustrates an embodiment of a comb 200. As shown in FIG. 1, the comb has at least one guide pin 201 and a plurality of well pins 202. As shown in FIG. 1, the comb 200 is structured and arranged to engage with the multi-well plate 100 where the guide pins 201 of the comb 200 engage with the guide holes 120 of the multi-well plate 100. When the guide pins 201 of the comb 200 engage with the guide holes 120 of the multi-well plate 100, the well-pins 202 insert into the plurality of wells 106 of the multi-well plate 100.

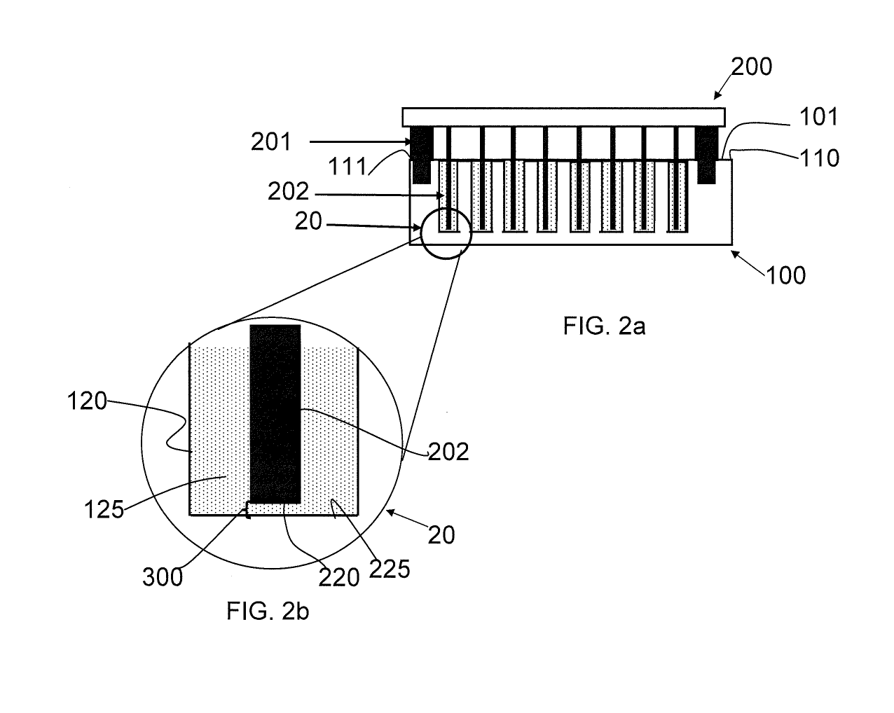

FIGS. 2a and 2b are illustrations of the comb 200 engaged with the multi-well plate 100. FIG. 2a is a cross-sectional view of a comb 200 engaged with the multi-well plate 100. FIG. 2 illustrates the guide pins 201 extending through the top surface 101, of the multi-well plate through a first side panel 110 and a second side panel 111. Guide pins 201 extend through the top surface through guide holes 120 (not shown). FIG. 2b is a blown-up illustration of the area 20 shown in FIG. 2a. FIG. 2b illustrates a well-pin 202 in a well 120. As shown in FIG. 2b, the well is filled with media 125. As shown in FIG. 2b, when the comb 200 is engaged with the multi-well plate 100, and a well-pin 202 extends into a well 120 of a multi-well plate 100, the well-pin 202 does not engage with the bottom surface 225 of the well 120. That is, there is a gap 300 between the bottom surface 220 of the well-pin 202 and the bottom surface 225 of the well 120, when the comb 200 is engaged with the multi-well plate 100. The well-pins 202 can be lowered into the wells of multi-well plate 100 so that the tip 220 of each well-pin 202 is near but not touching the bottom 225 of the well 120.

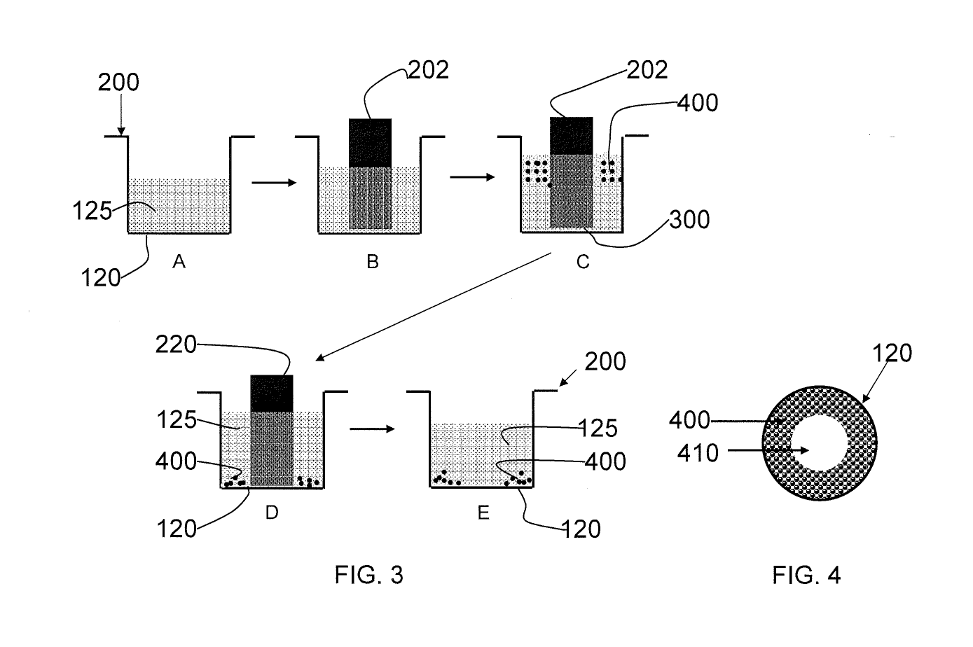

FIG. 3A-E is an illustration of a method of using the multi-well plate 100 and comb 200 to create a cell-exclusion cell culture. In Step A, culture medium 125 is added to the wells 120 of a multi-well plate. Media 125 is added to the wells 120 before well-pins 202 are introduced into the wells 120 so that air bubbles do not form between the well-pins 202 and the well bottom 225. Once the wells contain culture medium 125, in Step B, the well-pins can be lowered into the wells 120. In Step C, cells 400 can then be added using, for example, a multi-channel pipettor. Note that the well-pin 202 is inserted so as to leave a gap 300 between the bottom surface of the well 225 and the bottom surface of the well-pin 220. After the cells 400 settle to the bottom 225 of the wells 120, in Step D, the comb 200 is removed in Step E to provide well-defined cell-containing and cell-free areas that can be used for cell migration and related studies.

The well-pins 202 serve to block the deposition of cells during cell seeding, and hence create cell-free areas whose shape and size depend on the shape and size of the pins. In embodiments, the well-pins can be of any cross-sectional shape, for example, round, triangular, square, or any other shape. The guide pins 201 have three functions: (1) to center the blocking pins in each corresponding well; (2) to fix the height of the blocking pins and prevent them from touching the bottom of the wells; and, (3) to prevent the insert and hence the blocking pins from becoming dislodged during cell seeding and other handling steps.

Compared to existing technologies for cell-exclusion patterning, which rely on the direct contact of seeding stoppers (such as well-pins) and biocompatible gel (BCG) deposits with a well-bottom to exclude cells from adhering in the centers of wells of multi-well plates, the pin insertion devices described here offer a non-contact method that can exclude cells in selected areas during cell seeding. The comb thus has all of the advantages of the seeding stoppers and BCG deposits, and more. For example, like seeding stoppers and BCG deposits, the comb yields cell-free areas with consistent shape, size, and location, does not damage the cells, is simple and easy to use, is compatible with adherent cells, and is suitable for subsequent high-throughput screening (HTS) and high-content analysis (HCA). In addition, unlike the seeding stoppers and BCG deposits, the comb (because of its non-contact mechanism of operation) does not interfere with the cell culture surface, is suitable for patterning non-adherent cells also, and allows subsequent cell migration studies to be carried out with or without the blocking pins still present in the wells. For example, if the wells are coated with a coating to enhance cell culture, the insertion of a pin which comes into contact with the cell bottom might disrupt that coating. Or, the addition of a BCG would create a region that is coated with BCG, and not coated with the cell culture surface coating. Using the comb and multi-well devices embodied herein, it is possible to form a cell exclusion cell culture, while preserving a cell culture surface on the bottom of a well. As shown in FIG. 3, when the blocking pins are hollow, the cell-free areas can still be viewed by microscope even when the blocking pins are inside the wells.

FIG. 4 is an illustration of the bottom of a cell culture well 120 formed using the method described in FIG. 3, having cells 400 in a cell-exclusion ring, surrounding a cell-exclusion area 410.

In embodiments, the multi-well plate and the comb can be formed from any suitable material including plastic, glass or metal, or combinations. Suitable plastic materials include such polystyrene, polycarbonate, acrylic, polystyrene, or polyester, or any other polymer suitable for molding and commonly utilized in the manufacture of laboratory ware. The comb may be disposable or autoclavable. A disposable comb may be formed from material that is less durable than a reusable, autoclavable material. For example, a reusable, autoclavable comb may be formed from metal, while a disposable comb may be formed from plastic material.

The comb, with guide pins that can fit snuggly into guide holes in the frame of a multi-well plate serves several functions including: (1) centering the well-pins in each corresponding well; (2) fixing the height of the well-pins and preventing them from touching the bottom of the wells; and, (3) preventing the well-pins from becoming dislodged during cell seeding and other handling steps.

Embodiments described herein will be further clarified by the following examples.

### EXAMPLES

### Example 1

### Cell Culture

Materials.

Cytochalasin D was obtained from Tocris Bioscience and dissolved in dimethylsulfoxide to give 50 mM stock solutions.

Human lung carcinoma cell line A549 and human cervical carcinoma cell line HeLa were obtained from American Type Culture Collection (ATCC). Both cell lines were cultured in Dulbecco's Modified Eagle Medium (DMEM) supplemented with 10% fetal bovine serum and 1% penicillin-streptomycin (complete medium).

### Example 2

### Cell-Exclusion Patterning

Cell-exclusion patterning was carried out by a sequence of steps, as illustrated in FIG. 3. In Step A, complete medium was added to wells of a microtiter plate. The volume added was approximately 30 ul for 384-well plates or 75 ul for 96-well plates. In step B, a comb having guide pins and well pins was lowered into the microtiter plate and the blocking pins were locked into the desired wells and the guide pins into the corresponding guide holes. In step C, cells were introduced into the wells of the microtiter plate by adding a solution containing cells to the walls of the wells. The volume of the cell solution was approximately 20 ul for 384-well plates or 25-50 ul for 96-well plates. The cell density was 8000 cells per well and 30,000 cells per well for 384- and 96-well plates, respectively. In step D, the cells were allowed to settle to the well bottom inside a cell culture hood for about 45 min. The microplates were then placed inside a humidified incubator 37° C. and 5% CO₂ for 3-4 h to allow the cells to attach to the well bottom. In step E, the comb and the pins were removed from the wells. Drugs were then added, if necessary to carry out an assay.

### Example 3

### Imaging Cell Patterns

Cell patterns were imaged by bright-field or fluorescent microscopy or by using Corning Epic® label-free high-resolution optical resonance detection system (available from Corning Incorporated, Corning, N.Y.). The Epic® detection platform consists of an optical detection unit and a 384-well microplate with resonant waveguide grating biosensors embedded in the bottom of each well. The optical detection unit measures changes in the local index of refraction due to the presence of cells and changes in cell response at the sensor surface.

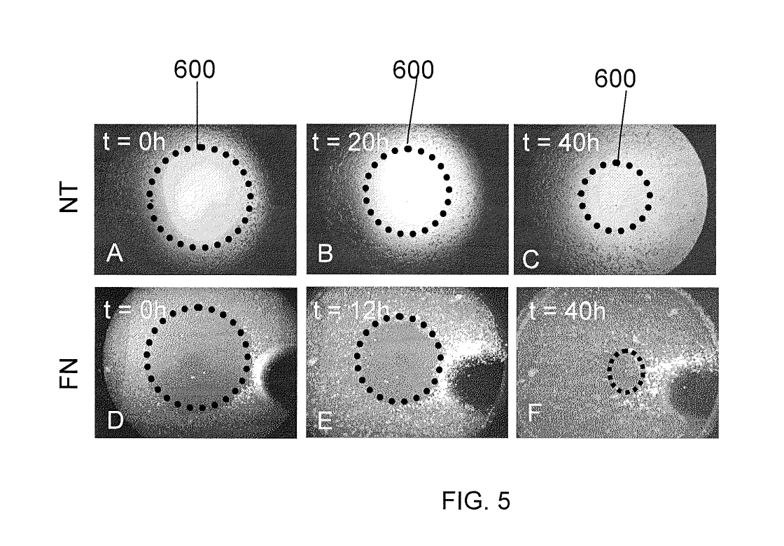

FIG. 5 A-G is a series of micrographs showing cells growing in a cell-exclusion patterned cell culture in non-treated microtiter wells (NT) (A-C) and in microtiter wells coated with Fibronectin (FN) (E-G) at time 0 (t=0 h) (A and D), time 12 hours (t=12 h) (E), time 20 hours (t=20 h) (B), and time 40 hours (t=40 h) (C and F). FIG. 5 shows that, over time, cells grow into the cell exclusion area 600 shown by the circle in FIG. 5 A, B, D, E and F. The structure on the right lower center side of figures D, E, and F are bubbles. These are considered artifacts.

### Example 4

### Cell Culture in Cell-Exclusion Patterned Cell Culture in the Presence and Absence of a Drug

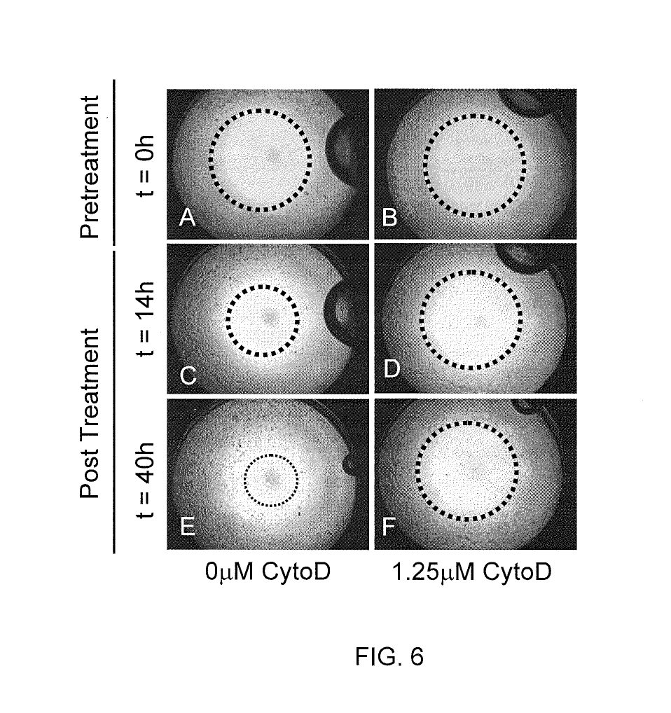

Cytochalasin D (CytoD) was added to wells to assess the effect of this drug on cell proliferation and migration. FIG. 6 A-F are micrographs showing cells growing in a cell-exclusion patterned cell culture on uncoated well bottoms in the absence (A, C, and E) and presence (B, D and F) of a pharmaceutical agent (in this case, CytoD) in an assay. Images were taken pretreatment (at t=0 h) (A and B), after 14 hours of treatment (t=14 h) (C and D), and after 40 hours of treatment (t=40 h) (E and F). FIG. 6 illustrates that, in the presence of CytoD, cells do not grow into the cell exclusion area over time.

### Example 5

### Cell Culture in the Presence and Absence of a Well-Pin

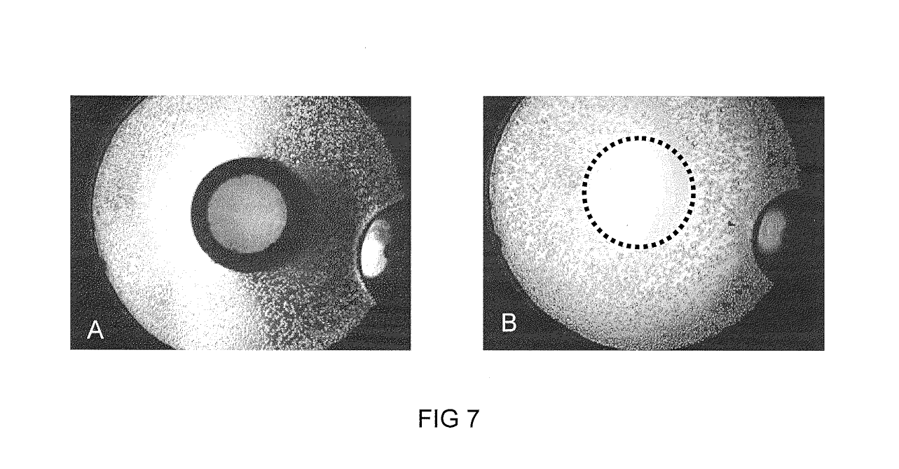

FIGS. 7 A and B are micrographs showing cells growing in a cell-exclusion patterned cell culture in the presence (A) and absence (B) of a pin in the well. In the embodiment shown in FIG. 7A, the blocking pin diameter is 0.8 mm. The embodiment shown in FIG. 7B was formed using a blocking pin having a diameter of 0.8 mm. The structure on the right side is a bubble, and is considered to be an artifact of the image.

### Example 6

### Resonant Wavelength Distribution Heat Maps Characterizing A549 Cells Cultured Atop a Corning Epic® Biosensor

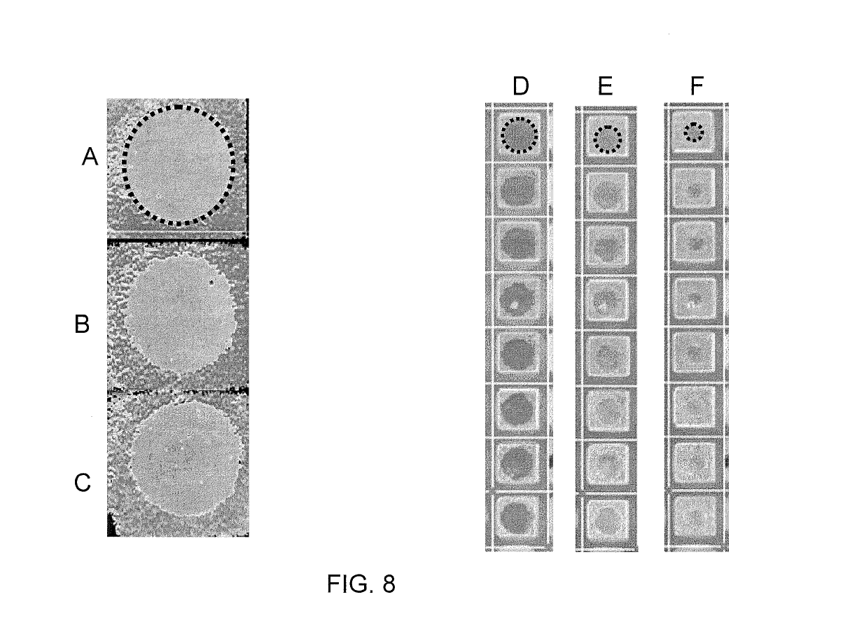

A549 cells were seeded at 8000 cells/well. Resonant wavelength distribution heat maps reflecting the growth and migration of A549 on an Epic® biosensor were captured using Corning EPIC® label-free high-resolution optical resonance detection systems with optical resolutions of 12 μm (FIGS. 8A, B and C) and 90 μm (FIGS. 8D, E and F), respectively.

FIG. 8 D-F is a series of resonant wavelength distribution heat maps showing A549 cells growing in a cell-exclusion patterned cell culture inside an Epic® microplate at time 0 (t=0 h) (D), time 24 hours (E), and time 48 hours (F).

Although several embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

1. A kit for cell-exclusion patterning comprising;
a multi-well plate comprising
a plurality of wells;
a first side panel and a second side panel
wherein the first side panel comprises a plurality of guide holes.

2. The kit of claim 1 wherein the second side panel of the multi-well plate comprises
a plurality of guide holes.

3. The kit of claim 1 wherein the multi-well plate comprises a 96 well plate or a 386 well plate.

4. The kit of claim 2 wherein the multi-well plate comprises a 96 well plate or a 386 well plate.

5. The kit of claim 1, further comprising a comb, wherein the comb comprises:
a comb bar;
at least one guide pin extending from the comb bar;
a plurality of blocking pins extending from the comb bar, each having a bottom surface;
wherein the at least one guide pin is structured and arranged to engage with a first side panel of a multi-well plate and
wherein the plurality of blocking pins are structured and arranged to extend into a plurality of wells of the multi-well plate.

6. The kit of claim 5 wherein the comb comprises two guide pins, a first guide pin structured and arranged to engage with a first side panel of a multi-well plate, and a second guide pin structured and arranged to engage with a second side panel of a multi-well plate.

7. The kit of claim 5 wherein the blocking pins are cylindrical.

8. The kit of claim 5 wherein the bottom surface of the blocking pins is flat.

9. A kit for making a multi-well cell culture plate for cell-exclusion patterning comprising:
(1) a comb, wherein the comb comprises:
a comb bar;
at least one guide pin extending from the comb bar;
a plurality of blocking pins extending from the comb bar, each having a bottom surface; and,
(2) A multi-well plate, wherein the multi-well plate comprises:
a plurality of wells, each well having side walls and a well bottom;
a first side panel and a second side panel;
wherein the first side panel comprises a plurality of guide holes;
wherein the at least one guide pin is structured and arranged to engage with one of the plurality of guide holes of the first side panel of the multi-well plate and wherein when the at least one guide pin is engaged with one of the plurality of guide holes of the first side panel of the multi-well plate, the plurality of blocking pins are inserted into the plurality of wells.

10. The kit of claim 9 wherein the second side panel comprises a plurality of guide holes.

11. The kit of claim 10 wherein the comb comprises two guide pins, structured and arranged to engage with a guide hole of the first side panel of the multi-well plate and a guide hole of the second side panel of the multi-well plate.

12. The kit of claim 9 wherein the blocking pins are cylindrical.

13. The kit of claim 9 wherein the bottom surface of the blocking pins is flat.

14. A method of using the kit of claim 9 for making a multi-well cell culture plate for cell-exclusion patterning comprising;
(a) engaging the comb with the multi-well plate so that the at least one guide pin is engaged with one of the plurality of guide holes of the first side panel of the multi-well plate and the plurality of blocking pins are inserted into the plurality of wells;
(b) adding cell culture media to the wells of the multi-well plate;
(c) adding cells to the wells of the multi-well plate;
(d) allowing cells to settle to the bottom of the wells of the multi-well plate;
(e) removing the comb from the multi-well plate.
